(19) United States
(12) Patent Application Publication
(10) Pub. No.: US 2025/0051671 A1
(43) Pub. Date: Feb. 13, 2025

(54) NATURAL GAS PROCESSING AND METHODS AND SYSTEMS RELATED THERETO

(71) Applicant: SAUDI ARABIAN OIL COMPANY, Dhahran (SA)

(72) Inventors: Saleh A. ALBENHAMAD, Udhailiyah (SA); Mohammed J. AL-ALI, Udhailiyah (SA); Hamad M. AL-FARHAN, Dhahran (SA)

(73) Assignee: SAUDI ARABIAN OIL COMPANY, Dhahran (SA)

(21) Appl. No.: 18/448,307

(22) Filed: Aug. 11, 2023

(51) Int. Cl. C10L 3/10; B01D 53/48; B01D 53/78

(52) U.S. Cl. CPC C10L 3/104; B01D 53/48; B01D 53/78; C10L 3/103; B01D 2252/2023; B01D 2252/20484; B01D 2257/30; C10L 2290/541

(57) ABSTRACT

Optimizing natural gas processing and/or reducing corrosion risk in natural gas processing may include, for example: introducing an acid gas stream to a sour gas feed stream, thereby producing an associated gas stream, wherein the sour gas feed stream originates from a high to low pressure letdown station, and wherein an amount of acid gas stream introduced to the sour gas feed stream is based on an initial H2S/CO2 ratio of the sour gas feed stream; and forming a recycle stream from a portion of the associated gas stream, wherein the recycle stream forms at least a portion of the acid gas stream.

### FIELD OF THE DISCLOSURE

The present disclosure relates generally to natural gas processing and, more particularly, to associated gas processing.

### BACKGROUND OF THE DISCLOSURE

Natural gas is the portable and preferred fuel of choice around the world. Natural gas burns more completely than other hydrocarbon fuels, including petroleum and coal; therefore, the combustion of natural gas may provide lower carbon dioxide emissions. Natural gas and similar products, including propane and other compressed-gas fuels, are much more efficient in engine and turbine combustion systems.

A commonly extracted form of natural gas is associated gas, also referred to as associated petroleum gas. Associated gas is generally found in or in close proximity to petroleum deposits. Associated gas compositions at extraction may vary depending on the reservoir in question. Thus, associated gas, like other extracted hydrocarbons, requires processing prior to delivery for use.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

A first nonlimiting example method of the present disclosure includes: introducing an acid gas stream to a sour gas feed stream, thereby producing an associated gas stream, wherein the sour gas feed stream originates from a high to low pressure letdown station, the acid gas steam has an H2S concentration from 45 mol % to 55 mol % and a CO2 concentration from 45 mol % to 55 mol %, and wherein an amount of acid gas stream introduced to the sour gas feed stream is based on an initial H2S/CO2 ratio of the sour gas feed stream; and forming a recycle stream from a portion of the associated gas stream, wherein the recycle stream forms at least a portion of the acid gas stream.

A second nonlimiting example method of the present disclosure includes: calculating an initial H2S/CO2 ratio of a sour gas feed stream; introducing a quantity of an acid gas stream to the sour gas feed stream, thereby producing an associated gas stream, wherein the acid gas stream has a H2S concentration from 45 mol % to 55 mol %, and a CO2 concentration from 45 mol % to 55 mol %, and wherein the quantity of the acid gas is based on the initial H2S/CO2 ratio of the sour gas feed stream; and forming a recycle stream from a portion of the associated gas stream, wherein the recycle stream forms at least a portion of the acid gas stream.

A nonlimiting example system of the present disclosure includes: an initial H2S/CO2 ratio of a sour gas feed conduit for conveying a sour gas feed stream; an acid gas conduit for conveying an acid gas stream, the acid gas conduit fluidly connected to the sour gas feed conduit, wherein the acid gas stream has a H2S concentration from 45 mol % to 55 mol %, and a CO2 concentration from 45 mol % to 55 mol %, and wherein a quantity of the acid gas stream is based on the initial H2S/CO2 ratio of the sour gas feed stream; and an associated gas conduit for conveying an associated gas stream, wherein the associated gas conduit is fluidly connected to and originates from the acid gas conduit and the sour gas feed conduit, and wherein the associated gas stream has a final H2S/CO2 ratio; and a recycle conduit for conveying a recycle stream originating from a portion of the associated gas stream, wherein the recycle stream forms at least a portion of the acid gas stream, and wherein a recycle fraction of the associated gas stream is from 1% to 5%.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a flow diagram of a nonlimiting example system of the present disclosure.

FIG. 2 is a graph showing CO2 data for a system of the present disclosure.

FIG. 3 is a graph showing H2S data for a system of the present disclosure.

FIG. 4 is a graph showing H2S fraction in a system of the present disclosure.

### DETAILED DESCRIPTION

Embodiments of the present disclosure will be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to natural gas processing and, more particularly, to associated gas processing.

The present disclosure includes methods and systems for optimizing and/or correcting for an associated gas processing system having a supply of higher than spec carbon dioxide content. As the composition of associated gas may vary naturally due to reservoir conditions, some associated gas streams fed to an associated gas processing facility may have higher carbon dioxide content than that for which the processing facility was originally designed. This may result in a lower hydrogen sulfide content than originally designed for. As a result of the input associated gas having a composition that with a varying specification, additional processing may be required, adding complexity and cost, and potentially causing delivery delays to customers due to off-specification gas.

Additionally, the presence of higher carbon dioxide content in a gas processing plant may increase the risk of corrosion, including, but not limited to, for example, sweet corrosion, the like, or any combination thereof.

“Corrosion” as used herein, and grammatical variations thereof, refers to deterioration of a material as a result of contact with a degradative species in its surroundings. In the case of the present disclosure, corrosion may include, but is not limited to, water wetting, sweet corrosion (e.g., CO2 corrosion), sour corrosion (e.g., H2S corrosion), microbial induced corrosion (MIC), top of the line corrosion (TLC), scale formation, solid accumulation, or any other corrosion method or type known in the art, as well as any combination thereof.

The present disclosure allows for introduction of an acid gas (e.g., a recycled acid gas) through a gas ejector to an associated gas stream, thus increasing the hydrogen sulfide content in the associated gas and increasing the H2S/CO2 ratio. As a result of the methods and systems of the present disclosure, associated gas may be processed more effectively, allowing optimal delivery of specified product from the associated gas processing facility, and/or additionally mitigating corrosion due to high carbon dioxide content in associated gas. Such mitigation of corrosion further permits avoidance of costly material upgrades, such as internal thermal insulation of equipment in the associated gas processing facility (e.g., spray coating with 316SS grade stainless steel).

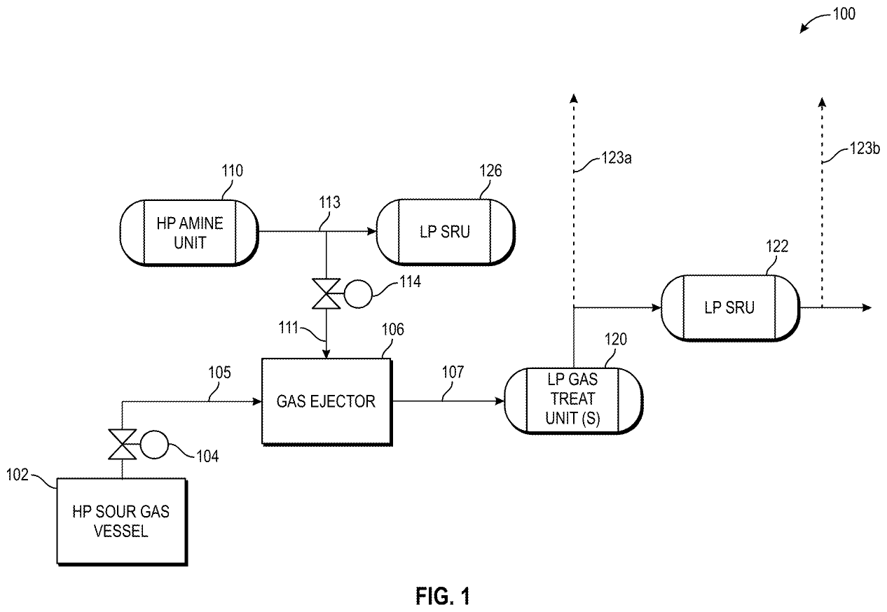

A nonlimiting example system of the present disclosure is shown in FIG. 1. System 100 includes wherein natural gas is inputted from a high pressure sour gas vessel 102 as an ejector motive gas, optionally through a valve 104, forming a sour gas feed stream 105. Sour gas feed stream 105 is fluidly connected to and combined with acid gas stream 111, a partially recycled stream originating from high pressure amine unit 110. High pressure amine unit 110 is fluidly connected to sulfur recovery stream 113 which is fluidly connected to high-pressure sulfur recovery unit 126. Stream 113 is partially recycled through optional control valve 114 forming acid gas stream 111 at gas ejector 106, subsequently fluidly connected to and forming associated gas stream 107. Associated gas stream 107 may be further processed through additional units including, for example, low pressure gas treatment unit(s) 120 and/or a low-pressure sulfur recovery unit 122. The portion of the associated gas stream 107 may be recycled as a recycle stream originating from the low pressure sulfur recovery unit 122 (shown as recycle stream 123a) or alternatively may be recycled from the low pressure gas treatment unit(s) 120 (shown as recycle stream 123b). The recycle stream 123a or 123b may form a portion of the acid gas stream 111 and subsequently flowing to gas ejector 106. It should be noted that additional inputs and outputs to the units described in FIG. 1 (system 100) may be present in any combination. It should further be noted that the sour gas feed stream, the acid gas stream, the sulfur recovery stream, the associated gas stream, and the recycle stream may each be conveyed by a sour gas feed conduit, an acid gas conduit, a sulfur recovery conduit, an associated gas conduit, and a recycle conduit, respectively.

“Sour gas,” “sour gas feed stream,” and grammatical variations thereof, as used herein refer to an input feed gas having a H2S concentration of 2 mol % or greater (or from 1 mol % to 5 mol %, or from 2 mol % to 5 mol %, or from 2 mol % to 10 mol %). The sour gas feed stream of the present disclosure originate from a high to low pressure letdown station, or any similar suitable apparatus.

The sour gas feed stream may have any suitable pressure, including, but not limited to, for example, a pressure from 150 psig to 400 psig (or 200 psig to 350 psig). The sour gas feed stream may have any suitable temperature, including, but not limited to, for example, a temperature from 75° F. to 125° F. (or 80° F. to 120° F.).

“Acid gas,” “acid gas stream,” and grammatical variations thereof, as used herein, refer to a stream having an H2S concentration from 40 mol % to 60 mol % (or 45 mol % to 55 mol %, or 47 mol % to 53 mol %), and a CO2 concentration from 40 mol % to 60 mol % (or 45 mol % to 55 mol %, or 47 mol % to 53 mol %),

The acid gas stream may have any suitable pressure, including, but not limited to, for example, a pressure from 1 psig to 25 psig, or 5 psig to 20 psig. The acid gas stream may have any suitable temperature, including, but not limited to, for example, a temperature from 75° F. to 125° F. or 80° F. to 120° F.

The pressure letdown may be any pressure letdown station capable of processing natural gas including associated gas, non-associated gas, or any combination thereof. One of ordinary skill in the art will be able to select and implement the use of a suitable pressure letdown station with the benefit of the present disclosure.

The gas ejector may be any suitable unit known in the art capable of gas ejection, including, but not limited to, for example, a Venturi ejector, the like, or any combination thereof.

The low pressure gas treatment units may be amine treating units. The low pressure gas treatment units may include units such as, for example, absorbers, flash drums, regenerators, coolers, heat exchangers, knockout drums, filters, the like, or any combination thereof. Said units may operate at a pressure of 200 psig or less (or 100 psig or less, or 50 psig or less, or 0.1 psig to 200 psig, or 0.1 psig to 100 psig).

The high pressure sulfur recovery unit and the low pressure sulfur recovery unit may each include any form of suitable sulfur recovery unit including, for example, preheaters, reaction furnaces, catalytic convertors, condensers, burners, heaters, thermal oxidizers, the like, or any combination thereof. Said low pressure sulfur recovery unit may operate at a pressure of 0.1 psig to 25 psig (or 0.1 to 15 psig, or 25 psig or less, or 15 psig or less).

The high pressure amine unit may include any form of suitable sulfur recovery unit including, for example a diglycolamine (DGA)-based processing unit, a monoethanolamine (MEA)-based processing unit, the like, or any combination thereof. Further examples of high pressure amine units may include, but are not limited to, absorbers, flash drums, regenerators, coolers, heat exchangers, knockout drums, filters, the like, or any combination thereof. Said unit may operate at a pressure of 250 to 10,000 psig (or 250 psig or greater, or 250 psig to 5,000 psig, or 500 psig to 10,000 psig).

Methods of the present disclosure may include calculating an initial H2S/CO2 ratio from a sour gas feed stream. An H2S/CO2 ratio may be calculated from a molar ratio of H2S and CO2 by dividing the mole fraction of H2S in a gas by the mole fraction of CO2 in a gas. The initial H2S/CO2 ratio may be calculated for a sour gas feed stream. The final H2S/CO2 ratio may be calculated for an associated gas stream. An H2S/CO2 ratio may be calculated by any suitable manual or automated means known to one of ordinary skill in the art. An initial H2S/CO2 ratio may be, for example, less than 0.15 (or less than 0.17, or less than 0.18, or from 0.01 to 0.15, or from 0.01 to 0.16, or from 0.01 to 0.17). A final H2S/CO2 ratio may be, for example, from 0.17 to 0.23 (or greater than 0.17, or greater than 0.18, or from 0.18 to 0.25, or from 0.18 to 0.3).

Methods of the present disclosure may further include wherein the acid gas stream is introduced to the sour gas feed stream, including at a gas ejector. The combination of acid gas stream and sour gas feed stream may produce an associated gas stream. The amount of acid gas stream introduced to the sour gas feed stream may be based on the initial H2S/CO2 ratio such that the introduction of the acid gas stream may increase the H2S/CO2 ratio (of the final H2S/CO2 ratio relative to the initial H2S/CO2 ratio). Such an increase in H2S/CO2 ratio may allow for performance changes as previously described, including an associated gas stream closer to a design specification as well as the potential for reduced corrosion.

Methods of the present disclosure may further include forming a recycle stream from a portion of the associated gas stream, wherein the recycle stream forms at least a portion of the acid gas stream. A recycle fraction of the associated gas stream may be calculated as a mole fraction of the associated gas stream that is directed toward the recycle stream. The recycle fraction of the associated gas stream may be from 1% to 5% (or from 2% to 4%, or about 2%). The recycle stream may originate from the associated gas stream at any point. It should be noted that the recycle stream may be processed through one or more units (including, for example, the high pressure amine unit and/or the gas ejector) before forming a portion of the associated gas stream.

As a result of methods and systems of the present disclosure, associated gas content may have an increased H2S/CO2 ratio (as previously described), thus mitigating corrosion due to otherwise elevated carbon dioxide content in associated gas. Methods and systems of the present disclosure may allow for reducing a corrosion rate of a steel pipe (e.g., carbon steel pipe, the like, or any combination thereof) carrying associated gas of the present disclosure to 5 mpy (mils per year) or less (or from 0.01 mpy to 10 mpy, or from 0.01 mpy to 5 mpy).

It should be noted that there may be additional equipment including, but not limited to, valves, pipelines, actuators, pumps, temperature sensors, electronic controllers, and the like that are customarily employed in hydrocarbon processing (e.g., gas processing) operations that, for the purpose of simplified schematic illustrations and description, may not be shown or described within the present disclosure.

To facilitate a better understanding of the embodiments of the present disclosure, the following examples of preferred or representative embodiments are given. In no way should the following examples be read to limit, or to define, the scope of the present disclosure.

### EXAMPLES

### Example 1

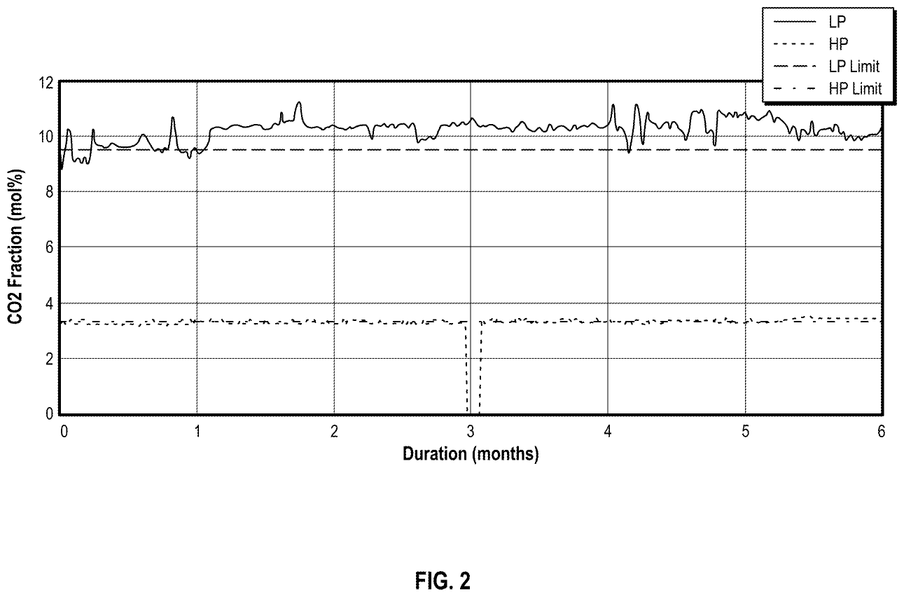

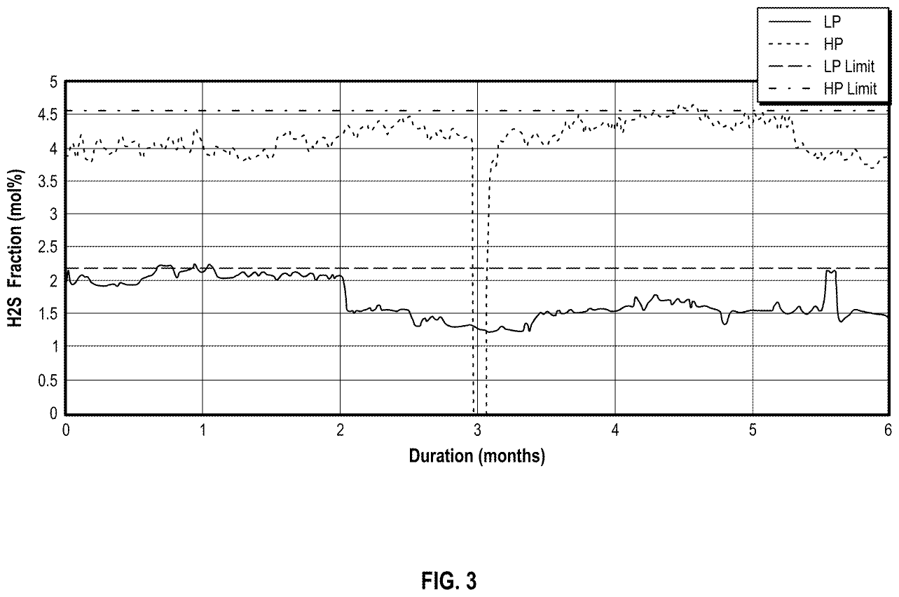

An experimental plant was measured for carbon dioxide and hydrogen sulfide content at both the high pressure and low pressure ends of the high pressure to low pressure gas letdown (see 102 of FIG. 1). The carbon dioxide mol % is shown in FIG. 2 and the sulfur dioxide mol % is shown in FIG. 3. As shown, there exists variability in the mole fractions of carbon dioxide and sulfur dioxide outside design specification limits over a period of about 6 months.

An average composition was taken for low pressure sour gas (at the low pressure end of the associated gas letdown) and for high pressure acid gas prior to recycling and combination. Data was taken over a period of 5 years through use of an online composition analyzer, and subsequently averaged. Composition data is shown in Table 1 below.

TABLE 1
Gas composition average.

| | LP Sour Gas Feed | HP Acid Gas |
|---|---|---|
| Component | (% mol) | (% mol) |
| H2S | 1.51 | 51.21 |
| CO2 | 10.22 | 48.15 |
| Benzene | — | 0.05 |
| Toluene | — | 0.12 |
| Xylene | — | 0.04 |
| C1 | 52.24 | 0.35 |
| C2 | 17.16 | 0.05 |
| C3 | 11.63 | 0.03 |
| NC4 | 3.21 | — |
| IC4 | 1.11 | — |
| C5+ | 1.86 | — |
| N2 | 0.86 | — |

### Example 2

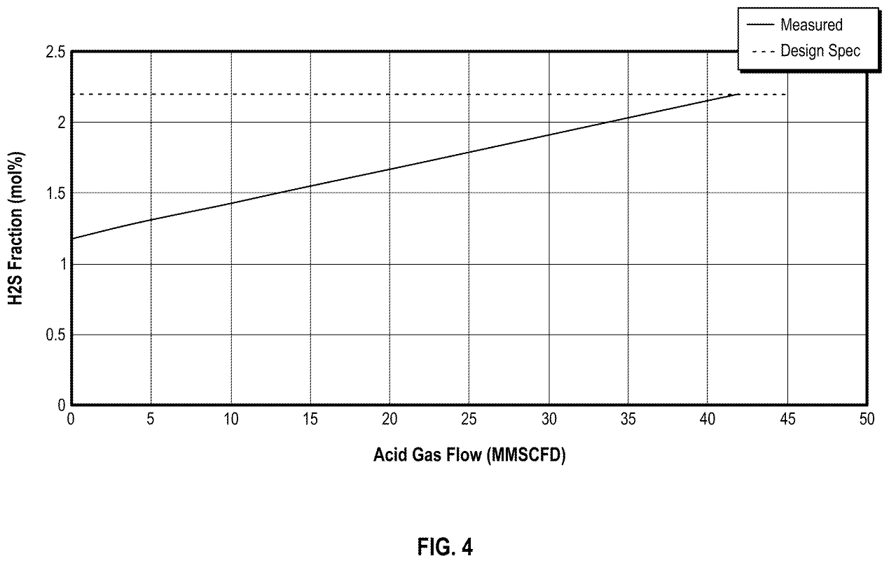

The experimental plant of Example 1 was fitted with a gas ejector at the high pressure to low pressure gas letdown so as to add acid gas to the low pressure sour gas. The acid gas quantity was increased incrementally so as to increase the H2S/CO2 ratio to a target of 0.2, allowing corrosion rate of carbon steel material to remain at or under 5 mils per year (mpy) per SAES-A-133 limits for carbon steel. Results of Example 2 are shown in FIG. 4 and also in Table 2 below.

TABLE 2
Gas flow and composition for associated gas.

| LP Sour Gas | Acid Gas | H2S | CO2 | |
|---|---|---|---|---|
| (MMSCFD) | (MMSCFD) | (mol % ) | (mol %) | H2S/CO2 Ratio |
| 1809 | 41.87 | 2.2 | 11.1 | 0.20 (Target) |
| 1812 | 38.77 | 2.13 | 11.05 | 0.19 |
| 1818 | 33.23 | 1.99 | 10.95 | 0.18 |
| 1823 | 27.69 | 1.86 | 10.85 | 0.17 |
| 1829 | 22.15 | 1.72 | 10.75 | 0.16 |
| 1834 | 16.61 | 1.59 | 10.65 | 0.15 |
| 1840 | 11.08 | 1.45 | 10.55 | 0.14 |
| 1845 | 5.538 | 1.32 | 10.45 | 0.13 |
| 1851 | 0 | 1.18 | 10.35 | 0.11 |

As visible, the increased flow of acid gas to the associated gas stream allows for an increase of the H2S/CO2 ratio to the target, allowing an H2S/CO2 ratio closer to the design specification of 0.24.

### ADDITIONAL EMBODIMENTS

Embodiments disclosed herein include:

Embodiment 1. A method comprising: introducing an acid gas stream to a sour gas feed stream, thereby producing an associated gas stream, wherein the sour gas feed stream originates from a high to low pressure letdown station, the acid gas steam has an H2S concentration from 45 mol % to 55 mol % and a CO2 concentration from 45 mol % to 55 mol %, and wherein an amount of acid gas stream introduced to the sour gas feed stream is based on an initial H2S/CO2 ratio of the sour gas feed stream; and forming a recycle stream from a portion of the associated gas stream, wherein the recycle stream forms at least a portion of the acid gas stream.

Embodiment 2. The method of Embodiment 1, wherein a recycle fraction of the associated gas stream is from 1% to 5%.

Embodiment 3. The method of Embodiment 1 or 2, wherein the initial H2S/CO2 ratio is less than 0.15.

Embodiment 4. The method of any one of Embodiments 1-3, further comprising: calculating a final H2S/CO2 ratio of the associated gas stream, wherein the final H2S/CO2 ratio is calculated after introducing the acid gas stream to the sour gas feed stream.

Embodiment 5. The method of Embodiment 4, wherein the final H2S/CO2 ratio is from 0.17 to 0.23.

Embodiment 6. The method of any one of Embodiments 1-5, wherein introducing the acid gas stream to the sour gas feed stream occurs at a gas ejector.

Embodiment 7. The method of Embodiment 6, wherein the gas ejector comprises a Venturi ejector.

Embodiment 8. The method of any one of Embodiments 1-7, wherein the recycle stream is formed from the associated gas stream after the associated gas stream has passed through a sulfur recovery unit.

Embodiment 9. The method of any one of Embodiments 1-8, wherein the recycle stream passes through a high pressure amine treatment unit prior to forming the at least a portion of the acid gas stream.

Embodiment 10. A method comprising: calculating an initial H2S/CO2 ratio of a sour gas feed stream; introducing a quantity of an acid gas stream to the sour gas feed stream, thereby producing an associated gas stream, wherein the acid gas stream has a H2S concentration from 45 mol % to 55 mol %, and a CO2 concentration from 45 mol % to 55 mol %, and wherein the quantity of the acid gas is based on the initial H2S/CO2 ratio of the sour gas feed stream; and forming a recycle stream from a portion of the associated gas stream, wherein the recycle stream forms at least a portion of the acid gas stream.

Embodiment 11. The method of Embodiment 10, wherein the initial H2S/CO2 ratio is less than 0.15

Embodiment 12. The method of Embodiment 10 or 11, further comprising: calculating a final H2S/CO2 ratio of the associated gas stream, wherein the final H2S/CO2 ratio is calculated after introducing the acid gas stream to the sour gas feed stream.

Embodiment 13. The method of Embodiment 12, wherein the final H2S/CO2 ratio is from 0.17 to 0.23.

Embodiment 14. The method of any one of Embodiments 10-13, wherein introducing the acid gas stream to the sour gas feed stream occurs at a gas ejector.

Embodiment 15. The method of Embodiment 14, wherein the gas ejector comprises a Venturi ejector.

Embodiment 16. The method of any one of Embodiments 10-15, wherein the initial H2S/CO2 gas ratio is calculated by dividing a mole fraction of CO2 by a mole fraction of H2S.

Embodiment 17. The method of any one of Embodiments 10-16, wherein the pressure of the acid gas stream is from 1 psig to 25 psig.

Embodiment 18. The method of any one of Embodiments 10-17, wherein the temperature of the acid gas stream is from 75° F. to 125° F.

Embodiment 19. The method of any one of Embodiments 10-18, wherein the pressure of the sour gas feed stream is from 150 psig to 400 psig.

Embodiment 20. The method of any one of Embodiments 10-19, wherein the temperature of the sour gas feed stream is from 75° F. to 125° F.

Embodiment 21. The method of any one of Embodiments 10-20, further comprising reducing a corrosion rate of a steel pipe carrying the associated gas stream to 5 mpy or less.

Embodiment 22. The method of Embodiment 21, wherein the steel pipe comprises carbon steel.

Embodiment 23. A system comprising: an initial H2S/CO2 ratio of a sour gas feed conduit for conveying a sour gas feed stream; an acid gas conduit for conveying an acid gas stream, the acid gas conduit fluidly connected to the sour gas feed conduit, wherein the acid gas stream has a H2S concentration from 45 mol % to 55 mol %, and a CO2 concentration from 45 mol % to 55 mol %, and wherein a quantity of the acid gas stream is based on the initial H2S/CO2 ratio of the sour gas feed stream; and an associated gas conduit for conveying an associated gas stream, wherein the associated gas conduit is fluidly connected to and originates from the acid gas conduit and the sour gas feed conduit, and wherein the associated gas stream has a final H2S/CO2 ratio; and a recycle conduit for conveying a recycle stream originating from a portion of the associated gas stream, wherein the recycle stream forms at least a portion of the acid gas stream, and wherein a recycle fraction of the associated gas stream is from 1% to 5%.

Embodiment 24. The method of Embodiment 23, further comprising a gas ejector, wherein the gas ejector fluidly connects the sour gas feed conduit, the acid gas conduit, and the associated gas conduit.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing.” “includes,” “including,” “comprises,” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized that these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A method comprising:
introducing an acid gas stream to a sour gas feed stream, thereby producing an associated gas stream,
wherein the sour gas feed stream originates from a high to low pressure letdown station, and the acid gas steam has an H2S concentration from 45 mol % to 55 mol % and a CO2 concentration from 45 mol % to 55 mol %, and
wherein an amount of the acid gas stream introduced to the sour gas feed stream is based on an initial H2S/CO2 ratio of the sour gas feed stream; and
forming a recycle stream from a portion of the associated gas stream, wherein the recycle stream forms at least a portion of the acid gas stream.

2. The method of claim 1, wherein a recycle fraction of the associated gas stream forming the recycle stream is from 1% to 5%.

3. The method of claim 1, wherein the initial H2S/CO2 ratio of the sour gas feed stream is less than 0.15.

4. The method of claim 1, further comprising:
calculating a final H2S/CO2 ratio of the associated gas stream, wherein the final H2S/CO2 ratio is calculated after introducing the acid gas stream to the sour gas feed stream, and wherein the final H2S/CO2 ratio of the associated gas stream is from 0.17 to 0.23.

5. The method of claim 1, wherein introducing the acid gas stream to the sour gas feed stream occurs at a gas ejector.

6. The method of claim 1, wherein the recycle stream is formed from the portion of the associated gas stream after the associated gas stream has passed through a sulfur recovery unit.

7. The method of claim 1, wherein the recycle stream passes through a high pressure amine treatment unit prior to forming the at least a portion of the acid gas stream.

8. A method comprising:
calculating an initial H2S/CO2 ratio of a sour gas feed stream;
introducing a quantity of an acid gas stream to the sour gas feed stream, thereby producing an associated gas stream,
wherein the acid gas stream has a H2S concentration from 45 mol % to 55 mol % and a CO2 concentration from 45 mol % to 55 mol %, and
wherein the quantity of the acid gas is based on the initial H2S/CO2 ratio of the sour gas feed stream; and
forming a recycle stream from a portion of the associated gas stream, wherein the recycle stream forms at least a portion of the acid gas stream.

9. The method of claim 8, wherein the initial H2S/CO2 ratio of the sour gas feed stream is less than 0.15.

10. The method of claim 8, further comprising:
calculating a final H2S/CO2 ratio of the associated gas stream, wherein the final H2S/CO2 ratio is calculated after introducing the acid gas stream to the sour gas feed stream.

11. The method of claim 10, wherein the final H2S/CO2 ratio of the associated gas stream is from 0.17 to 0.23.

12. The method of claim 8, wherein introducing the quantity of the acid gas stream to the sour gas feed stream occurs at a gas ejector.

13. The method of claim 12, wherein the gas ejector comprises a Venturi ejector.

14. The method of claim 8, wherein the initial H2S/CO2 gas ratio is calculated by dividing a mole fraction of CO2 by a mole fraction of H2S.

15. The method of claim 8, wherein a pressure of the quantity of the acid gas stream is from 1 psig to 25 psig.

16. The method of claim 8, wherein a pressure of the sour gas feed stream is from 150 psig to 400 psig.

17. The method of claim 8, further comprising reducing a corrosion rate of a steel pipe carrying the associated gas stream to 5 mpy or less.

18. The method of claim 17, wherein the steel pipe comprises carbon steel.

19. A system comprising:
an initial H2S/CO2 ratio of a sour gas feed conduit for conveying a sour gas feed stream;
an acid gas conduit for conveying an acid gas stream, the acid gas conduit fluidly connected to the sour gas feed conduit,
wherein the acid gas stream has a H2S concentration from 45 mol % to 55 mol % and a CO2 concentration from 45 mol % to 55 mol %, and
wherein a quantity of the acid gas stream is based on the initial H2S/CO2 ratio of the sour gas feed stream; and
an associated gas conduit for conveying an associated gas stream, wherein the associated gas conduit is fluidly connected to and originates from the acid gas conduit and the sour gas feed conduit, and wherein the associated gas stream has a final H2S/CO2 ratio; and
a recycle conduit for conveying a recycle stream originating from a portion of the associated gas stream, wherein the recycle stream forms at least a portion of the acid gas stream, and wherein a recycle fraction of the associated gas stream is from 1% to 5%.

20. The method of claim 19, further comprising a gas ejector, wherein the gas ejector fluidly connects the sour gas feed conduit, the acid gas conduit, and the associated gas conduit.
